(19) United States
(12) Patent Application Publication
(10) Pub. No.: US 2026/0253453 A1
(43) Pub. Date: Aug. 27, 2026

(54) IMAGE PROCESSING METHOD AND APPARATUS, AND ELECTRONIC DEVICE, AND STORAGE MEDIUM

(71) Applicant: Beijing Zitiao Network Technology Co., Ltd., Beijing (CN)

(72) Inventors: Kai LIU, Beijing (CN); Xu WANG, Beijing (CN)

(21) Appl. No.: 18/871,071

(22) PCT Filed: Aug. 8, 2023
(86) PCT No.: PCT/CN2023/111620

§ 371 Date: Dec. 2, 2024

(30) Foreign Application Priority Data
Aug. 12, 2022 (CN) 202210968846.9

(51) Int. Cl. G06V 40/40; G06V 10/22; G06V 10/26

(52) U.S. Cl. CPC G06V 40/45; G06V 10/22; G06V 10/26

(57) ABSTRACT

A method and apparatus, an electronic device, and a storage medium for image processing. The method for image processing includes: acquiring an image sequence of a target object in response to a live body detection trigger operation, wherein the image sequence includes an image to be detected (S110); determining, for the image to be detected, multiple frames of reference images associated with the image to be detected in acquisition time from the image sequence (S120); determining a risk factor of the image to be detected based on a region to be detected in the multiple frames of reference images, wherein the region to be detected at least includes a region where a verification organ performing a preset verification action is located, and the risk factor indicates whether the target object is a live body (S130).

### CROSS-REFERENCE TO RELATED APPLICATION(S)

The present application is a national stage application filed under 35 U.S.C. 371 based on International Patent Application No. PCT/CN2023/111620, filed Aug. 8, 2023, which claims priority to Chinese Patent Application No. 202210968846.9, filed with the China National Intellectual Property Administration on Aug. 12, 2022, the disclosures of which are incorporated herein by reference in their entities.

### FIELD

The present disclosure relates to the field of computer application technologies, and for example, to a method and apparatus, an electronic device, and a storage medium for image processing.

### BACKGROUND

Identity verification is one of important means for protecting information security of users, and is favored by users for its simplicity, convenience, and efficiency. With continuous development of smart devices, user identity information stored in the smart devices is more extensive and private, and therefore, requirements for security of identity verification are higher and higher.

### SUMMARY

The present disclosure provides a method and apparatus, an electronic device, and a storage medium for image processing, to improve accuracy of live body detection.

According to an aspect of the present disclosure, a method for image processing is provided. The method includes:
acquiring an image sequence of a target object in response to a live body detection trigger operation, where the image sequence includes an image to be detected;
determining, for the image to be detected, multiple frames of reference images associated with the image to be detected in acquisition time from the image sequence;
p determining a risk factor of the image to be detected based on a region to be detected in the multiple frames of reference images, where the region to be detected at least includes a region where a verification organ performing a preset verification action is located, and the risk factor indicates whether the target object is a live body; and
determining a live body detection result corresponding to the target object based on the risk factor of the image to be detected.

According to another aspect of the present disclosure, an apparatus for image processing is provided. The apparatus includes:
an image sequence acquisition module configured to acquire an image sequence of a target object in response to a live body detection trigger operation, where the image sequence includes an image to be detected;
a reference image determination module configured to determine, for the image to be detected, multiple frames of reference images associated with the image to be detected in acquisition time from the image sequence;
a risk factor determination module configured to determine a risk factor of the image to be detected based on a region to be detected in the multiple frames of reference images, where the region to be detected at least includes a region where a verification organ performing a preset verification action is located, and the risk factor indicates whether the target object is a live body; and
a detection result determination module configured to determine a live body detection result corresponding to the target object based on the risk factor of the image to be detected.

According to another aspect of the present disclosure, an electronic device is provided. The electronic device includes:
at least one processor; and
a memory communicatively connected to the at least one processor, where the memory is stored with a computer program executable by the at least one processor, and the computer program, when executed by the at least one processor, causes the at least one processor to be capable of executing the above method for image processing.

According to another aspect of the present disclosure, a computer-readable storage medium is provided. The computer-readable storage medium is stored with computer instructions, and the computer instructions, when executed by a processor, causing to perform the above method image processing.

According to another aspect of the present disclosure, a computer program product is provided. The computer program product includes a computer program carried on a non-transitory computer-readable medium, and the computer program includes program code for executing the above method for image processing.

### BRIEF DESCRIPTION OF THE DRAWINGS

FIG. 1 is a schematic flowchart of an image processing method according to an embodiment of the present disclosure;

FIG. 2 is a schematic flowchart of another image processing method according to an embodiment of the present disclosure;

FIG. 3 is a schematic flowchart of still another image processing method according to an embodiment of the present disclosure;

FIG. 4 is a schematic flowchart of still another image processing method according to an embodiment of the present disclosure;

FIG. 5 is a schematic flowchart of an execution process of an example of an image processing method according to an embodiment of the present disclosure;

FIG. 6 is a schematic diagram of a structure of an image processing apparatus according to an embodiment of the present disclosure; and

FIG. 7 is a schematic diagram of a structure of an image processing electronic device according to an embodiment of the present disclosure.

### DETAILED DESCRIPTION OF EMBODIMENTS

Embodiments of the present disclosure are described below with reference to the accompanying drawings. Although some embodiments of the present disclosure are shown in the drawings, the present disclosure may be implemented in various forms, and these embodiments are provided for understanding the present disclosure. The drawings and embodiments of the present disclosure are only for illustrative purposes.

The plurality of steps described in the method implementations of the present disclosure may be performed in different orders and/or performed in parallel. In addition, additional steps may be included and/or the execution of the illustrated steps may be omitted in the method implementations. The scope of the present disclosure is not limited in this respect.

The terms “include/comprise” and variations thereof used herein are an open-ended inclusion, namely, “include/comprise.” The term “based on” is “at least partially based on.” The term “an embodiment” means “at least one embodiment”; the term “another embodiment” means “at least one another embodiment”; and the term “some embodiments” means “at least some embodiments.” Related definitions of other terms will be given in the description below.

Concepts such as “first” and “second” mentioned in the present disclosure are only used to distinguish different apparatuses, modules, or units, and are not used to limit an order or interdependence of functions performed by these apparatuses, modules, or units.

Modifiers such as “one” and “a plurality of” mentioned in the present disclosure are illustrative and not restrictive, and persons skilled in the art should understand that, unless the context clearly indicates otherwise, the modifiers should be understood as “one or more”.

Names of messages or information exchanged between a plurality of apparatuses in the implementations of the present disclosure are used for illustrative purposes only, and are not used to limit the scope of these messages or information.

Before the technical solutions disclosed in the embodiments of the present disclosure are used, a user shall be informed, in an appropriate manner in accordance with relevant laws and regulations, of the type, scope of use, and usage scenarios of the personal information involved in the present disclosure, and the user's authorization shall be obtained.

For example, a prompt message is sent to the user in response to receiving an active request from the user, to explicitly prompt the user that an operation requested by the user will need to acquire and use the user's personal information. Therefore, the user can choose, based on the prompt message, whether to provide the personal information to a software or hardware device such as an electronic device, an application, a server, or a storage medium performing the operation of the technical solution of the present disclosure.

In an implementation, a manner of sending a prompt message to the user in response to receiving an active request from the user may be, for example, a pop-up window, and the prompt message may be presented in the pop-up window in text. In addition, the pop-up window may further carry a selection control for the user to select “agree” or “disagree” to provide the personal information to the electronic device.

The above notification and user authorization obtaining process are only schematic and do not limit the implementation of the present disclosure. Other manners that comply with relevant laws and regulations may also be applied to the implementation of the present disclosure.

Data (including the data itself, acquisition of the data, or use of the data) involved in the technical solution of the present disclosure shall comply with requirements of corresponding laws and regulations and relevant provisions.

In many identity verification scenarios, before an identity is verified, live body detection is first performed, to add a layer of protection for maintaining information security. However, in a related live body detection manner, when live body detection is performed, the live body detection is usually attacked by a local disturbance type, and accuracy of a live body detection result cannot be ensured, thereby affecting information security.

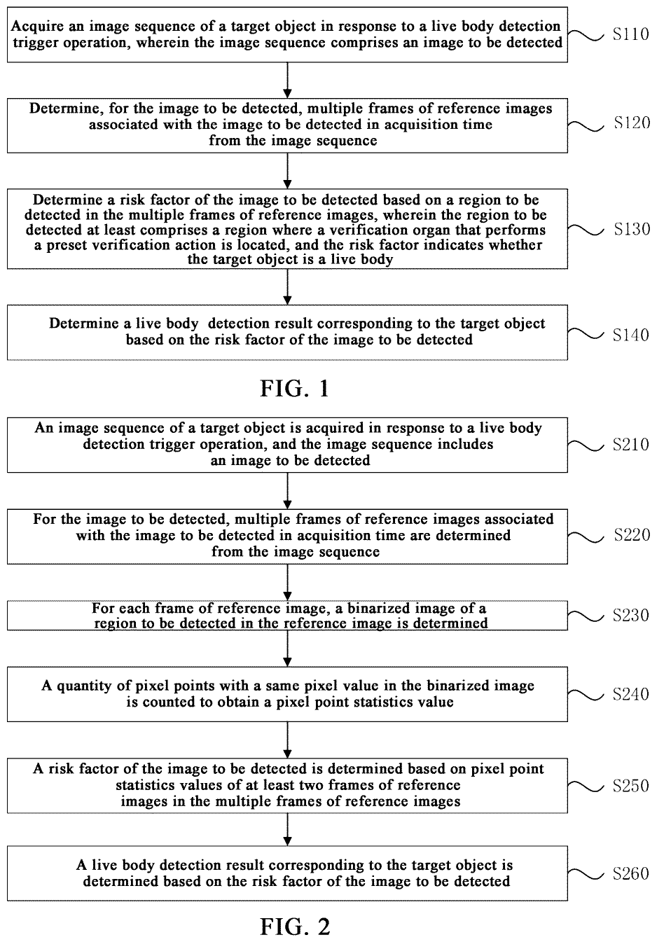

FIG. 1 is a schematic flowchart of an image processing method according to an embodiment of the present disclosure. The embodiment of the present disclosure is applicable to a live body detection scenario. The method may be performed by an image processing apparatus. The apparatus may be implemented in a form of software and/or hardware, for example, implemented by an electronic device, and the electronic device may be a mobile terminal, a personal computer (PC), a server, or the like.

As shown in FIG. 1, the method includes the following steps.

In S110, an image sequence of a target object is acquired in response to a live body detection trigger operation, and the image sequence includes an image to be detected.

The live body detection trigger operation may be an operation for triggering to activate a live body detection process. In this embodiment of the present disclosure, there may be various live body detection trigger operations that may activate the live body detection process, and an operation manner of the live body detection trigger operation is not limited herein. The live body detection trigger operation may be a contact operation or a non-contact operation.

Before the step of “acquiring an image sequence of a target object in response to a live body detection trigger operation”, the method further includes: receiving a live body detection trigger operation. Receiving the live body detection trigger operation includes at least one of the following operations:
receiving a control trigger operation on a preset live body detection start control; obtaining an image to be detected that is acquired by a photographing apparatus associated with live body detection; receiving a voice instruction or gesture information for activating a live body detection process; and detecting a target trigger event, and the target trigger event may be an event associated with live body detection and used for activating the live body detection process.

For example, the target trigger event includes at least one of the following events: a current time point being a preset detection time point, the current time point being in a preset detection period, a detected service risk, and an image to be detected being received that is transmitted by a third party.

In this embodiment of the present disclosure, the live body detection start control may be an interactive control for starting a live body detection function or activating a live body detection process. The live body detection start control may be a physical control or a virtual control. For example, the live body detection start control may be a virtual control that is arranged in an application interface. The live body detection start control may be presented in various forms. For example, the live body detection start control may be an interface element identified by using a picture, text, a symbol, or the like in the application interface, may be a preset trigger area in the application interface, may be a slidable control, or may be a control in an option form. A control trigger operation on the live body detection start control may also be various, for example, may be a click operation (such as a single click or a double click), a press operation (such as a long press or a short press), a hover operation, an activity operation, or an operation of inputting a preset trajectory.

Each frame of image acquired by the photographing apparatus associated with the live body detection may be used as the image to be detected; or an image is extracted from an image sequence acquired by the photographing apparatus associated with the live body detection based on a preset image extraction frame rate, and the extracted image is used as the image to be detected; or each frame of image acquired by the photographing apparatus associated with the live body detection is subjected to image recognition, and an image in which target image information is recognized is used as the image to be detected. The target image information may be information included in the image and used for activating the live body detection process, for example, may be a detection object to be detected whether the detection object is a live body.

There may be many approaches for receiving the live body detection trigger operation. The above is merely an example of the manner of receiving the live body detection trigger operation, and is not a limitation. In actual application, a generation approach for the live body detection trigger operation may be set based on an actual requirement.

The target object may be an object to be subjected to live body detection. The target object may be an object with a live physiological feature, or may be an object without a live physiological feature. For example, the target object may be a live body, a photo that includes or does not include a live body, a still screen, or the like. The image sequence may be a plurality of frames of images acquired for the target object over time. The image sequence may be a plurality of frames of images in a video source acquired for the target object. The image sequence of the target object may be acquired by an image acquisition apparatus associated with live body detection. The acquired image sequence includes a plurality of frames of images to be detected, so that live body detection may be performed based on change information of the target object.

In S120, for the image to be detected, multiple frames of reference images associated with the image to be detected in acquisition time are determined from the image sequence.

The reference images may be images in the image sequence that are used for determining a risk factor of the image to be detected.

In an embodiment, the multiple frames of reference images are a preset quantity of images in preceding images of the image to be detected that are closest to the image to be detected in acquisition time.

The preceding images are images in the image sequence that are acquired before the image to be detected. A preset quantity of images in the image sequence that are acquired before a reference time point and are immediately next to the reference time point may be obtained, with the acquisition time of the image to be detected used as the reference time point, to be used as the multiple frames of reference images. A value of the preset quantity may be set based on an actual requirement, and is not limited herein. For example, the preset quantity may be 9, 10, or 15.

For example, each frame of preceding image of the image to be detected in the image sequence is used as a reference image.

In this embodiment of the present disclosure, the reference images may include or may not include the image to be detected. A preset quantity of images that include the image to be detected and that are immediately next to the image to be detected in acquisition time are obtained from the image sequence, to be used as the multiple frames of reference images. Alternatively, a preset quantity of images in the image sequence that are acquired after the reference time point and are immediately next to the reference time point are obtained, with the acquisition time of the image to be detected used as the reference time point, to be used as the multiple frames of reference images.

In an embodiment, the multiple frames of reference images are images obtained by performing equal-spacing sampling on a preset quantity of images in preceding images of the image to be detected that are closest to the image to be detected in acquisition time. Sampling may be performed once for every preset quantity of frames in the preceding images of the image to be detected, in an order from close to far in acquisition time from the image to be detected, to obtain the multiple frames of reference images.

The region to be detected may be a region that can be extracted from the reference images and that is used for performing live body verification on the target object. The region to be detected may be a region where a verification organ performing a preset verification action is located in live body detection. The preset verification action may be an execution action preset for the target object and that may be used for performing live body verification on the target object. For example, the preset verification action may be one action or a combination of a plurality of actions such as blinking, mouth opening, head shaking, and head nodding. The verification organ may be an organ corresponding to the execution of the preset verification action. For example, the verification organ may be an eye, a mouth, a head, or the like. The region to be detected may be a region corresponding to the verification organ. For example, the region to be detected may be an eye region, a mouth region, a head region, or the like.

The risk factor may be a factor that is determined based on the reference images of the target object and that can be used as a basis for live body detection. In this embodiment of the present disclosure, determining the risk factor of the image to be detected based on the region to be detected in the multiple frames of reference images may be determining the risk factor of the image to be detected based on the region to be detected in a plurality of frames of reference images that are adjacent to each other in time sequence. The advantage of this setting is that change characteristics of the plurality of frames of reference images in the time sequence can be captured, thereby providing a basis for improving accuracy of live body detection.

In S130, a risk factor of the image to be detected is determined based on a region to be detected in the multiple frames of reference images, and the region to be detected at least includes a region where a verification organ performing a preset verification action is located, and the risk factor indicates whether the target object is a live body.

Whether there is a risk in live body detection of the target object may be determined based on the risk factor, and then whether the target object is a live body is indicated, to determine a live body detection result corresponding to the target object. The live body detection result may be another operation of continuing to perform live body detection, ending live body detection, or outputting a result of live body detection. Live body detection may be implemented based on a combination of a plurality of technical means, and one or more preset operations may be performed to complete live body detection. In this embodiment of the present disclosure, for another operation that may be performed for live body detection, reference may be made to related technologies, which will not be described herein again. Compared with the related technologies, the method for image processing in this embodiment of the present disclosure adds the determination of the risk factor, so that attention can be effectively paid to the risk in live body detection, thereby resisting the risk, and ensuring accuracy of live body detection.

If it is determined based on the risk factor of the image to be detected that the target object is a live body, a successful live body detection result corresponding to the target object may be determined; or if it is determined based on the risk factor of the image to be detected that the target object is not a live body, a failed live body detection result corresponding to the target object may be determined.

If a failed live body detection result corresponding to the target object is determined, at least one of stopping to perform live body detection on the target object, displaying prompt information indicating that live body detection fails, and displaying detection guidance information may be performed. The prompt information indicating that live body detection fails may be prompt information for prompting a user that live body verification of the target object fails. There may be various prompt information indicating that live body detection fails. For example, the prompt information indicating that live body detection fails may be generated graphic or text prompt information, voice prompt information, light prompt information, or the like. The detection guidance information may be information for guiding a user to operate after live body detection fails. There may be various detection guidance information. For example, the detection guidance information may be generated graphic or text prompt information, voice prompt information, light prompt information, or the like. For example, the user may be guided to exit a live body detection process or perform live body detection again.

In S140, a live body detection result corresponding to the target object is determined based on the risk factor of the image to be detected.

The live body detection result corresponding to the target object is determined based on the risk factor of each frame of image to be detected, or the live body detection result corresponding to the target object is determined based on change information or fluctuation information between the risk factors of the multiple frames of images to be detected.

In this embodiment of the present disclosure, live body detection is a method for determining whether an object has a live feature in some identity verification scenarios, and may be simply divided into silent live body and action live body. The action live body mainly uses an action that requires a live body to cooperate, for example, blinking, mouth opening, head shaking, or head nodding. Whether a user is a live body is verified based on facial key points and facial tracking technology. Considering that blinking is an action with the smallest perception of the live body, the most natural, and the easiest to implement, the live body algorithm may determine whether a live body exists based on the blinking action. For example, blinking may be determined based on the facial key points. However, for this blinking determination manner, it is often difficult to defend against an attack of a local disturbance type, and it is extremely easy to break. For example, a foreign object such as a pen or a finger is used to quickly disturb an eye region of a face photo to drive key points of the eye to move, thereby evading detection of the live body algorithm and attacking a real-name verification system.

According to the technical solution of this embodiment of the present disclosure, an image sequence of a target object is acquired in response to a live body detection trigger operation, and the image sequence includes an image to be detected; for the image to be detected, multiple frames of reference images associated with the image to be detected in acquisition time are determined from the image sequence, which fully considers dynamic changes of a live feature; a risk factor of the image to be detected is determined based on a region to be detected in the multiple frames of reference images, and the region to be detected at least includes a region where a verification organ performing a preset verification action is located, and the risk factor indicates whether the target object is a live body; and a live body detection result corresponding to the target object is determined based on the risk factor of the image to be detected. Therefore, the technical problem of low accuracy of a live body detection result in the related art is solved, the risk in live body detection is effectively avoided, and accuracy of live body detection is improved.

FIG. 2 is a flowchart of another method for image processing according to Embodiment 2 of the present disclosure. This embodiment describes how to determine the risk factor of the image to be detected based on the region to be detected in the reference images in the foregoing embodiment.

As shown in FIG. 2, the method includes the following steps.

In S210, an image sequence of a target object is acquired in response to a live body detection trigger operation, and the image sequence includes an image to be detected.

In S220, for the image to be detected, multiple frames of reference images associated with the image to be detected in acquisition time are determined from the image sequence.

In S230, for each frame of reference image, a binarized image of a region to be detected in the reference image is determined.

The binarized image may be an image obtained by performing binarization on the region to be detected in the reference image. In this embodiment of the present disclosure, binarization is performed on the region to be detected in the reference image, for example, pixel points in the region to be detected may be classified into two categories, so that change information in the image may be easily extracted, recognition efficiency of the image can be increased, and accuracy of live body detection can be improved.

Determining a binarized image of a region to be detected in the reference image includes: cropping the region to be detected in the reference image to obtain an image of the region to be detected; and performing binarization on the image of the region to be detected to obtain the binarized image.

Cropping may be first performed on the region to be detected in the reference image to obtain an image of the region to be detected, and then binarization is performed on the image of the region to be detected to obtain a binarized image. Cropping the region to be detected in the reference image may include: locating and cropping the reference image by using a key-point model image corresponding to the image to be detected. For example, a plurality of key points in the key-point model image corresponding to the image to be detected may be aligned with a plurality of key points in the reference image, and then a region to be detected in the reference image is determined based on positions of the plurality of key points in the key-point model image, to locate the region to be detected. Finally, the reference image is cropped to obtain the image of the region to be detected.

Performing binarization on the image of the region to be detected may include: performing binarization on the image of the region to be detected based on a preset pixel point segmentation threshold. The preset pixel point segmentation threshold may be a threshold set for dividing pixel points in the image of the region to be detected into two categories. In this embodiment of the present disclosure, the preset pixel point segmentation threshold may be set based on an actual application scenario, and a value of the preset pixel point segmentation threshold is not limited herein. For example, the preset pixel point segmentation threshold may be 130 or 150.

Performing binarization on the image of the region to be detected based on the preset pixel point segmentation threshold may be: dividing pixel values of pixel points in the image of the region to be detected into two classification intervals based on the preset pixel point segmentation threshold, and each classification interval corresponds to a different pixel value; determining the classification interval to which the pixel value of each pixel point in the image of the region to be detected belongs; and setting the pixel value of the pixel point as a pixel value corresponding to the classification interval to which the pixel value belongs to obtain the binarized image of the region to be detected.

For example, comparing the pixel value of each pixel point in the image of the region to be detected with the preset pixel point segmentation threshold, setting the pixel value of a pixel point whose pixel value is less than or equal to the preset pixel point segmentation threshold to a first value, and setting the pixel value of a pixel point whose pixel value is greater than the preset pixel point segmentation threshold to a second value, to obtain the binarized image of the region to be detected.

For example, if the selected preset pixel point segmentation threshold is 130, performing binarization on the image of the region to be detected based on the preset pixel point segmentation threshold may be: comparing the pixel value of each pixel point in the image of the region to be detected with 130, setting the pixel value of a pixel point whose pixel value is less than or equal to 130 to 0, and setting the pixel value of a pixel point whose pixel value is greater than 130 to 1, to obtain the binarized image of the region to be detected.

Determining a binarized image of a region to be detected in the reference image includes: performing binarization on the reference image; and cropping the region to be detected in the binarized reference image to obtain the binarized image.

As described above, binarization may also be first performed on the reference image, and then the region to be detected in the binarized reference image is cropped to obtain a binarized image. A manner of performing binarization on the reference image may be referred to the manner of performing binarization on the image of the region to be detected described above, and details are not described herein again.

In S240, a quantity of pixel points with a same pixel value in the binarized image is counted to obtain a pixel point statistics value.

A total quantity of pixel points corresponding to one-pixel value in the binarized image may be counted to obtain a pixel point statistics value. For example, assuming that pixel values of pixel points in the binarized image are 0 or 1, a total quantity of pixel points whose pixel values are 0 or 1 in the binarized image may be counted to obtain a pixel point statistics value.

In S250, a risk factor of the image to be detected is determined based on pixel point statistics values of at least two frames of reference images in the multiple frames of reference images.

For each frame of reference image, a pixel point statistics value is determined based on a binarized image of a region to be detected. Then, the risk factor of the image to be detected is determined based on pixel point statistics values corresponding to the multiple frames of reference images. For the multiple frames of reference images used for determining the risk factor, a binarization manner and a pixel point statistics manner are the same, that is, the pixel point statistics values corresponding to the multiple frames of reference images need to be obtained by counting a same pixel value.

Determining a risk factor of the image to be detected based on pixel point statistics values of at least two frames of reference images in the multiple frames of reference images includes: calculating a variance of the pixel point statistics values of the at least two frames of reference images in the multiple frames of reference images; and determining the risk factor of the image to be detected based on the variance.

When the variance of the pixel point statistics values of the at least two frames of reference images is calculated, there may be various approaches for obtaining the at least two frames of reference images.

Calculating a variance of pixel point statistics values of at least two frames of reference images in the multiple frames of reference images includes:
obtaining at least two frames of reference images within a preset acquisition time range in the multiple frames of reference images; and calculating a variance of pixel point statistics values of the at least two frames of reference images.

The multiple frames of reference images are obtained based on the preset acquisition time range, and a variance of pixel point statistics values of the multiple frames of reference images is calculated. Then, the risk factor of the image to be detected is determined based on the calculated variance. The at least two frames of reference images within the preset acquisition time range may be all or some of the reference images within the preset acquisition time range. One or more variances may be calculated based on the selected reference images. Then, the risk factor of the image to be detected is determined based on the one or more variances. In this embodiment of the present disclosure, the preset acquisition time range should comply with an application scenario of this embodiment of the present disclosure, and is not limited herein.

Calculating a variance of pixel point statistics values of at least two frames of reference images in the multiple frames of reference images includes:
obtaining a preset quantity of reference images in the multiple frames of reference images, and calculating a variance of pixel point statistics values of the preset quantity of reference images.

A variance may be calculated based on the pixel point statistics values of the multiple frames of reference images within the preset acquisition time range or the pixel point statistics values of the preset quantity of reference images, and the calculated variance is used as the risk factor of the image to be detected; or the multiple frames of reference images within the preset acquisition time range or the preset quantity of reference images may be obtained in a plurality of obtaining manners, each obtained reference image is used as a group, a variance is calculated based on pixel point statistics values of the multiple frames of reference images in each reference image group, and then the risk factor of the image to be detected is determined based on variances corresponding to the plurality of reference image groups. For example, an average value of the variances corresponding to the plurality of reference image groups may be calculated based on the variances corresponding to the plurality of reference image groups, and the average value is used as the risk factor of the image to be detected.

In S260, a live body detection result corresponding to the target object is determined based on the risk factor of the image to be detected.

In this embodiment of the present disclosure, in a live body detection process, normally, a value of the risk factor is relatively small; and when an abnormal situation such as disturbance of a foreign object occurs, the value of the risk factor fluctuates severely. Based on this, whether there is a risk in live body detection may be determined, and then a live body detection result corresponding to the target object is determined based on whether there is a risk in live body detection.

In this embodiment of the present disclosure, for each frame of reference image, a binarized image of a region to be detected is obtained by cropping and binarization, so that an image can be more focused, and a data amount of image processing can be reduced, which is beneficial to improving efficiency of image processing. A quantity of pixel points with a same pixel value in the binarized image is counted to obtain a pixel point statistics value, and then the multiple frames of reference images within the preset acquisition time range or the preset quantity of reference images are obtained to calculate the variance of the pixel point statistics values of the multiple frames of reference images; and the variance is used as the risk factor of the image to be detected. Change information of a same type of pixel points in different regions to be detected can be focused on, and a risk of live body detection can be accurately predicted, so that a result of live body detection is more accurate.

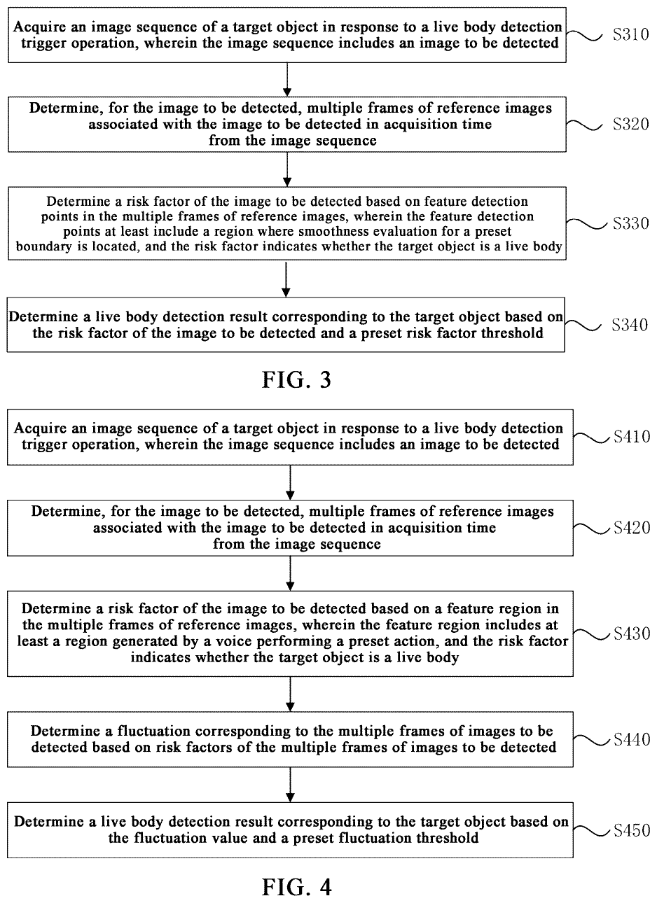

FIG. 3 is a flowchart of still another image processing method according to Embodiment 3 of the present disclosure. This embodiment describes how to determine the live body detection result corresponding to the target object based on the risk factor of the image to be detected in the foregoing embodiment.

As shown in FIG. 3, the method includes the following steps.

In S310, an image sequence of a target object is acquired in response to a live body detection trigger operation, and the image sequence includes an image to be detected.

In S320, for the image to be detected, multiple frames of reference images associated with the image to be detected in acquisition time are determined from the image sequence.

In S330, a risk factor of the image to be detected is determined based on a region to be detected in the multiple frames of reference images, and the region to be detected at least includes a region where a verification organ performing a preset verification action is located, and the risk factor indicates whether the target object is a live body.

In S340, a live body detection result corresponding to the target object is determined based on the risk factor of the image to be detected and a preset risk factor threshold.

The preset risk factor threshold may be a critical value for determining which live body detection result is used for live body detection of the target object. A value of the preset risk factor threshold may be set based on an actual requirement, and is not limited herein. There may be one or more preset risk factor thresholds. A normal range and a risk range may be determined based on the preset risk factor threshold. If the risk factor is within the normal range, it is determined that there is no risk in live body detection of the target object; or if the risk factor is within the risk range, it is determined that there is a risk in live body detection of the target object, and the live body detection result corresponding to the target object is determined based on whether there is a risk in live body detection.

When risk factors of the multiple frames of images to be detected are calculated, it may be determined whether the risk factor of each frame of image to be detected is within the normal range or the risk range, and then whether there is a risk in live body detection of the target object is determined based on a quantity of images to be detected that are within the risk range or the normal range, or a proportion of the quantity of images to be detected that are within the risk range or the normal range in a total quantity of images to be detected for which risk factors are calculated, and then the live body detection result corresponding to the target object is determined.

According to the technical solution of this embodiment of the present disclosure, a risk of live body detection can be determined based on the risk factors of the multiple frames of images to be detected, and a result can be simply and quickly determined in a threshold comparison manner, ensuring efficiency of risk prediction in live body detection and adding a guarantee for accuracy of live body detection in a simple and effective manner.

FIG. 4 is a flowchart of an image processing method according to Embodiment 4 of the present disclosure. This embodiment describes how to determine the live body detection result corresponding to the target object based on the risk factor of the image to be detected in the foregoing embodiment.

As shown in FIG. 4, the method includes the following steps.

In S410, an image sequence of a target object is acquired in response to a live body detection trigger operation, and the image sequence includes an image to be detected.

In S420, for the image to be detected, multiple frames of reference images associated with the image to be detected in acquisition time are determined from the image sequence.

In S430, a risk factor of the image to be detected is determined based on a region to be detected in the multiple frames of reference images, and the region to be detected at least includes a region where a verification organ performing a preset verification action is located, and the risk factor indicates whether the target object is a live body.

In S440, a fluctuation value corresponding to the multiple frames of images to be detected is determined based on risk factors of the multiple frames of images to be detected.

The fluctuation value may be a change value of values of two risk factors. The fluctuation value may be an absolute change value or a relative change value between the two risk factors.

In an embodiment, a difference between risk factors of each two frames of images to be detected that are adjacent to each other in acquisition time is calculated, and the difference is used as the fluctuation value corresponding to the multiple frames of images to be detected. According to the technical solution, a plurality of fluctuation values corresponding to the multiple frames of images to be detected may be calculated based on more than two frames of images to be detected. In other words, there may be one or more fluctuation values corresponding to the multiple frames of images to be detected.

In an embodiment, a largest risk factor and a smallest risk factor are determined from the risk factors of the multiple frames of images to be detected, a difference between the largest risk factor and the smallest risk factor is calculated, and the calculated difference is used as the fluctuation value corresponding to the multiple frames of images to be detected.

In an embodiment, two frames of images to be detected are randomly selected from the multiple frames of images to be detected, a difference between risk factors of the selected two frames of images to be detected is calculated, and the calculated difference is used as the fluctuation value corresponding to the multiple frames of images to be detected.

In S450, a live body detection result corresponding to the target object is determined based on the fluctuation value and a preset fluctuation threshold.

A fluctuation value between risk factors of the multiple frames of images to be detected is calculated, and then the fluctuation value is compared with the preset fluctuation threshold to determine the live body detection result corresponding to the target object.

The preset fluctuation threshold may be a critical value for determining the live body detection result corresponding to the target object based on a fluctuation value between two or more risk factors. Whether there is a risk in live body detection of the target object may be determined based on whether the fluctuation value between the risk factors of the multiple frames of images to be detected exceeds the preset fluctuation threshold, and then the live body detection result corresponding to the target object is determined based on whether there is a risk in live body detection.

When two or more fluctuation values are calculated, it may be determined whether a largest fluctuation value exceeds the preset fluctuation threshold, and then whether there is a risk in live body detection of the target object is determined based on a quantity of fluctuation values that exceed the preset fluctuation threshold, or a proportion of the quantity of fluctuation values that exceed the preset fluctuation threshold in a total quantity of all calculated fluctuation values, and then the live body detection result corresponding to the target object is determined.

According to the technical solution of this embodiment, whether there is a risk in live body detection may be determined based on a fluctuation condition of the risk factors of the multiple frames of images to be detected, and then the live body detection result corresponding to the target object is determined, so that change information between the multiple frames of images to be detected is fully focused on, which is more suitable for detection of a live feature and is beneficial to improving accuracy of live body detection.

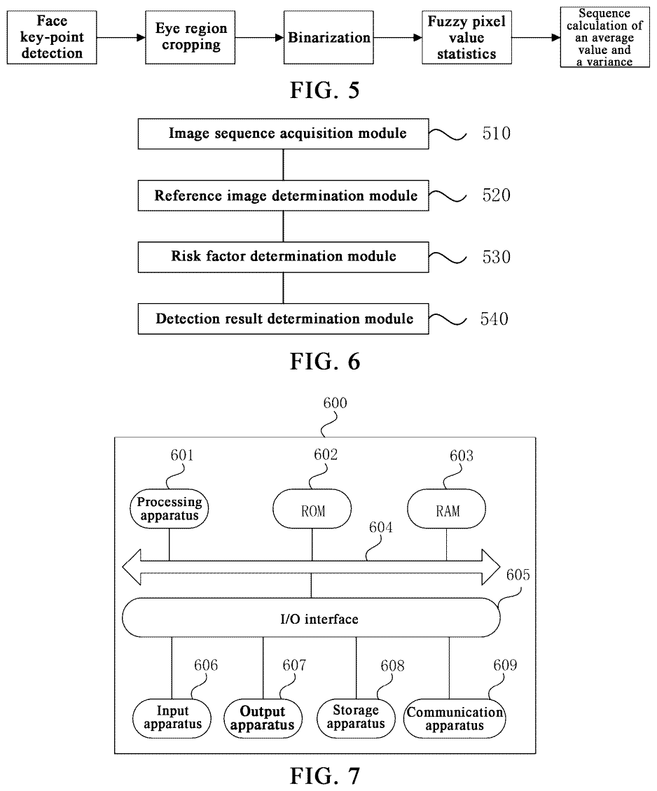

FIG. 5 is a schematic flowchart of an execution process of an example of an image processing method according to an embodiment of the present disclosure. An image processing method according to an embodiment of the present disclosure is described by using an example in which an image to be detected is a face image and a region to be detected is an eye region. As shown in FIG. 5, the execution process of the image processing method mainly includes face key-point detection, eye region cropping, binarization, horizontal and vertical pixel value statistics, and sequence calculation of an average value and a variance. The region to be detected is represented by an eye region, a pixel point segmentation threshold is represented by, a pixel point statistics value is represented by, and a variance of the pixel point statistics value is represented by Var.

Steps of the image processing method in this example are as follows:
1. Face key-point detection: Positioning the eye region of the face image by using a face key-point model.
2. Eye region cropping: Cropping the eye region in the face image based on a positioning result.
3. Binarization: Selecting a threshold a to binarize the eye region, to obtain a binarized image, setting a pixel value of a pixel point whose pixel value is less than or equal to in the binarized image to 0, and setting a pixel value of a pixel point whose pixel value is greater than % to 1.
4. Horizontal and vertical pixel value statistics: Performing pixel value statistics on the binarized image in a horizontal (row) or vertical (column) manner, and selecting to count a quantity of pixel points whose pixel values are 0 or a quantity of pixel points whose pixel values are 1, to obtain a result β.
5. Sequence calculation of an average value and a variance:
1) Performing the same processing on a plurality of frames of face images in a period of time sequence, to obtain a sequence, which is simply recorded as: d=[β1, β2, . . ., βi] , where i represents an ith frame of face image, and βi represents a pixel point statistics value of the ith frame of face image.
2) Selecting a time window corresponding to a specific quantity of face images, and taking nine frames as an example, calculating an average value and a variance of pixel point statistics values in the time window, and recording the variance as Var.
The Var may be used as a risk factor for determining a risk. The Var is relatively small in a normal blinking process, but fluctuates severely when there is disturbance of a foreign object. Key-point fluctuation of the eye region in a case of disturbance of the foreign object can be effectively avoided by using the risk factor, to avoid making a wrong determination.

According to the technical solution of this embodiment of the present disclosure, a problem that a face key-point-based blinking algorithm cannot resist a local disturbance attack can be solved. A risk factor is defined by performing statistics on distribution of pixel values in the horizontal and vertical directions of the eye region. An idea of determining whether there is disturbance of a foreign object in the eye region by using a horizontal and vertical statistics and using a variance of the horizontal and vertical statistics as a wind direction factor to avoid risks is used, to implement determination of a live body risk. A local disturbance attack can be effectively defended, and common attack means such as a photo and a still screen can be effectively resisted, thereby helping a user to identify a fraud, and ensuring rights and interests of the user.

FIG. 6 is a schematic diagram of a structure of an image processing apparatus according to an embodiment of the present disclosure. As shown in FIG. 6, the apparatus includes: an image sequence acquisition module 510, a reference image determination module 520, a risk factor determination module 530, and a detection result determination module 540.

The image sequence acquisition module 510 is configured to acquire an image sequence of a target object in response to a live body detection trigger operation, where the image sequence includes an image to be detected; the reference image determination module 520 is configured to determine, for the image to be detected, multiple frames of reference images associated with the image to be detected in acquisition time from the image sequence; the risk factor determination module 530 is configured to determine a risk factor of the image to be detected based on a region to be detected in the multiple frames of reference images, where the region to be detected at least includes a region where a verification organ performing a preset verification action is located, and the risk factor indicates whether the target object is a live body; and the detection result determination module 540 is configured to determine a live body detection result corresponding to the target object based on the risk factor of the image to be detected.

According to the technical solution of this embodiment of the present disclosure, an image sequence of a target object is acquired in response to a live body detection trigger operation, where the image sequence includes an image to be detected; for the image to be detected, multiple frames of reference images associated with the image to be detected in acquisition time are determined from the image sequence, which fully considers dynamic changes of a live feature; a risk factor of the image to be detected is determined based on a region to be detected in the multiple frames of reference images, where the region to be detected at least includes a region where a verification organ performing a preset verification action is located, and the risk factor indicates whether the target object is a live body; and a live body detection result corresponding to the target object is determined based on the risk factor of the image to be detected. Therefore, the technical problem of low accuracy of a live body detection result in the related art is solved, the risk in live body detection is effectively avoided, and accuracy of live body detection is improved.

The risk factor determination module 530 includes: a binarized image determination sub-module, a pixel point statistics value determination sub-module, and a risk factor determination sub-module.

The binarized image determination sub-module is configured to determine, for each frame of reference image, a binarized image of a region to be detected in the reference image; the pixel point statistics value determination sub-module is configured to count a quantity of pixel points with a same pixel value in the binarized image to obtain a pixel point statistics value; and the risk factor determination sub-module is configured to determine a risk factor of the image to be detected based on pixel point statistics values of at least two frames of reference images in the multiple frames of reference images.

The binarized image determination sub-module is configured to:
crop the region to be detected in the reference image to obtain an image of the region to be detected; and perform binarization on the image of the region to be detected to obtain the binarized image.

The binarized image determination sub-module is configured to:
perform binarization on the reference image; and crop the region to be detected in the binarized reference image to obtain the binarized image.

The risk factor determination sub-module includes: a pixel point statistics value variance calculation unit and a risk factor determination unit.

The pixel point statistics value variance calculation unit is configured to calculate a variance of pixel point statistics values of at least two frames of reference images in the multiple frames of reference images; and the risk factor determination unit is configured to determine the risk factor of the image to be detected based on the variance.

The pixel point statistics value variance calculation unit is configured to:
obtain at least two frames of reference images within a preset acquisition time range in the multiple frames of reference images; and calculate a variance of pixel point statistics values of the at least two frames of reference images.

The pixel point statistics value variance calculation unit is configured to:
obtain a preset quantity of reference images in the multiple frames of reference images, and calculate a variance of pixel point statistics values of the preset quantity of reference images.

The detection result determination module 540 is configured to:
determine a live body detection result corresponding to the target object based on the risk factor of the image to be detected and a preset risk factor threshold.

The detection result determination module 540 is configured to:
determine a fluctuation value corresponding to the multiple frames of images to be detected based on risk factors of the multiple frames of images to be detected; and determine a live body detection result corresponding to the target object based on the fluctuation value and a preset fluctuation threshold.

The multiple frames of reference images are a preset quantity of images in preceding images of the image to be detected that are closest to the image to be detected in acquisition time.

The multiple frames of reference images are images obtained by equally spaced sampling of a preset quantity of images in preceding images of the image to be detected that are closest to the image to be detected in acquisition time.

The image processing apparatus provided in this embodiment of the present disclosure may perform the image processing method provided in any embodiment of the present disclosure, and has corresponding functional modules and effects for performing the method.

The plurality of units and modules included in the above apparatus are divided according to functional logic, but are not limited to the foregoing division, as long as corresponding functions can be implemented. In addition, names of the plurality of functional units are merely for the purpose of differentiating from each other, and are not used to limit the scope of protection of this embodiment of the present disclosure.

FIG. 7 is a schematic diagram of a structure of an electronic device according to an embodiment of the present disclosure. The following describes with reference to FIG. 7, which is a schematic diagram of a structure of an electronic device (for example, a terminal device or a server in FIG. 7) 600 suitable for implementing this embodiment of the present disclosure. The terminal device in this embodiment of the present disclosure may include a mobile terminal such as a mobile phone, a notebook computer, a digital broadcast receiver, a personal digital assistant (PDA), a tablet computer (PAD), a portable multimedia player (PMP), and a vehicle-mounted terminal (for example, a vehicle navigation terminal), and a fixed terminal such as a digital television (TV) and a desktop computer. The electronic device 600 shown in FIG. 7 is merely an example, and shall not impose any limitation on the function and scope of use of this embodiment of the present disclosure.

As shown in FIG. 7, the electronic device 600 may include a processing apparatus (for example, a central processing unit, a graphics processing unit, etc.) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 7 shows the electronic device 600 having a variety of apparatuses, it is not required to implement or have all of the shown apparatuses. It may be an alternative to implement or have more or fewer apparatuses.

According to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 609 and installed, installed from the storage apparatus 608, or installed from the ROM 602. When the computer program is executed by the processing apparatus 601, the above-mentioned functions defined in the method of this embodiment of the present disclosure are performed.

Names of messages or information exchanged between a plurality of apparatuses in the implementation of the present disclosure are used for illustrative purposes only, and are not used to limit the scope of these messages or information.

The electronic device provided in this embodiment of the present disclosure and the image processing method provided in the above embodiment belong to the same concept. For technical details that are not described in detail in this embodiment, reference may be made to the above embodiment, and this embodiment has the same effect as the above embodiment.

An embodiment of the present disclosure provides a computer storage medium having stored thereon a computer program that, when executed by a processor, implements the image processing method provided in the above embodiments.

The computer-readable medium described above in the present disclosure may be a computer-readable signal medium, a computer-readable storage medium, or any combination thereof. The computer-readable storage medium may be, for example, electric, magnetic, optical, electromagnetic, infrared, or semiconductor systems, apparatus, or devices, or any combination thereof. Examples of the computer-readable storage medium may include: an electrical connection having one or more wires, a portable computer magnetic disk, a hard disk, random access memory (RAM), read-only memory (ROM), erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained in the computer-readable medium may be transmitted by any suitable medium, including: electric wires, optical cables, radio frequency (RF), etc., or any suitable combination thereof.

In some implementations, the client and the server may communicate using any currently known or future-developed network protocol such as the hypertext transfer protocol (HTTP), and may be interconnected with digital data communication (for example, a communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The computer-readable medium described above may be contained in the foregoing electronic device. Alternatively, the computer-readable medium may exist independently, without being assembled into the electronic device.

The computer-readable medium carries one or more programs that, when executed by the electronic device, cause the electronic device to: acquire an image sequence of a target object in response to a live body detection trigger operation, where the image sequence includes an image to be detected; determine, for the image to be detected, multiple frames of reference images associated with the image to be detected in acquisition time from the image sequence; determine a risk factor of the image to be detected based on a region to be detected in the multiple frames of reference images, where the region to be detected at least includes a region where a verification organ performing a preset verification action is located, and the risk factor indicates whether the target object is a live body; and determine a live body detection result corresponding to the target object based on the risk factor of the image to be detected.

The computer program code for performing the operations of the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate possible system architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be executed substantially in parallel, or they can sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself in some cases. For example, the first obtaining unit may also be described as “a unit for obtaining at least two Internet protocol addresses”.

The functions described herein above may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of the present disclosure, the machine-readable medium may be a tangible medium that may contain or store a program used by or in combination with an instruction execution system, apparatus, or device. The machine-readable medium may be a machine-readable signal medium or a machine-readable storage medium. The machine-readable medium may include electronic, magnetic, optical, electromagnetic, infrared, or semiconductor systems, apparatus, or devices, or any suitable combination thereof. Examples of the machine-readable storage medium may include: an electrical connection having one or more wires, a portable computer magnetic disk, a hard disk, RAM, ROM, EPROM or flash memory, an optical fiber, a portable compact disk read-only memory (CD-ROM), an optical storage device, a magnetic storage device, or any suitable combination thereof.

In addition, although a plurality of operations is depicted in a specific order, it should be understood as requiring these operations to be performed in the specific order shown or in a sequential order. Under certain circumstances, multitasking and parallel processing may be advantageous. Similarly, although a plurality of implementation details is included in the foregoing discussions, these details should not be construed as limiting the scope of the present disclosure. Some features that are described in the context of separate embodiments can also be implemented in combination in a single embodiment. In contrast, various features described in the context of a single embodiment may also be implemented in a plurality of embodiments individually or in any suitable sub combination.

1. A method for image processing, comprising:
acquiring an image sequence of a target object in response to a live body detection trigger operation, wherein the image sequence comprises an image to be detected;
determining, for the image to be detected, multiple frames of reference images associated with the image to be detected in acquisition time from the image sequence;
determining a risk factor of the image to be detected based on a region to be detected in the multiple frames of reference images, wherein the region to be detected at least comprises a region where a verification organ performing a preset verification action is located, and the risk factor indicates whether the target object is a live body; and
determining a live body detection result corresponding to the target object based on the risk factor of the image to be detected.

2. The method for image processing of claim 1, wherein determining a risk factor of the image to be detected based on a region to be detected in the multiple frames of reference images comprises:
determining, for each frame of reference image, a binarized image of a region to be detected in the reference image;
counting a quantity of pixel points with a same pixel value in the binarized image to obtain a pixel point statistics value; and
determining the risk factor of the image to be detected based on pixel point statistics values of at least two frames of reference images in the multiple frames of reference images.

3. The method for image processing of claim 2, wherein determining a binarized image of a region to be detected in the reference image comprises:
cropping the region to be detected in the reference image to obtain an image of the region to be detected; and
performing binarization on the image of the region to be detected to obtain the binarized image.

4. The method for image processing of claim 2, wherein determining a binarized image of a region to be detected in the reference image comprises:
performing binarization on the reference image; and
cropping the region to be detected in the binarized reference image to obtain the binarized image.

5. The method for image processing of claim 2, wherein determining a risk factor of the image to be detected based on pixel point statistics values of at least two frames of reference images in the multiple frames of reference images comprises:
calculating a variance of pixel point statistics values of the at least two frames of reference images in the multiple frames of reference images; and
determining the risk factor of the image to be detected based on the variance.

6. The method for image processing of claim 5, wherein calculating a variance of pixel point statistics values of the at least two frames of reference images in the multiple frames of reference images comprises:
obtaining at least two frames of reference images within a preset acquisition time range in the multiple frames of reference images; and
calculating the variance of pixel point statistics values of the at least two frames of reference images.

7. The method for image processing of claim 5, wherein calculating a variance of pixel point statistics values of the at least two frames of reference images in the multiple frames of reference images comprises:
obtaining a preset quantity of reference images in the multiple frames of reference images to calculate the variance of pixel point statistics values of the preset quantity of reference images.

8. The method for image processing of claim 1, wherein determining a live body detection result corresponding to the target object based on the risk factor of the image to be detected comprises:
determining the live body detection result corresponding to the target object based on the risk factor of the image to be detected and a preset risk factor threshold.

9. The method for image processing of claim 1, wherein determining a live body detection result corresponding to the target object based on the risk factor of the image to be detected comprises:
determining a fluctuation value corresponding to the multiple frames of images to be detected based on risk factors of the multiple frames of images to be detected; and
determining the live body detection result corresponding to the target object based on the fluctuation value and a preset fluctuation threshold.

10. The method for image processing of claim 1, wherein the multiple frames of reference images are a preset quantity of images in preceding images of the image to be detected that are closest to the image to be detected in acquisition time.

11. The method for image processing of claim 1, wherein the multiple frames of reference images are images obtained by equally spaced sampling of a preset quantity of images in preceding images of the image to be detected that are closest to the image to be detected in acquisition time.

12. (canceled)

13. An electronic device, comprising:
at least one processor;
a storage apparatus configured to store at least one program;
wherein the at least one program, when executed by the at least one processor, causes the at least one processor:
acquire an image sequence of a target object in response to a live body detection trigger operation, wherein the image sequence comprises an image to be detected;
determine, for the image to be detected, multiple frames of reference images associated with the image to be detected in acquisition time from the image sequence;
determine a risk factor of the image to be detected based on a region to be detected in the multiple frames of reference images, wherein the region to be detected at least comprises a region where a verification organ performing a preset verification action is located, and the risk factor indicates whether the target object is a live body; and
determine a live body detection result corresponding to the target object based on the risk factor of the image to be detected.

14. A non-transitory storage medium containing computer-executable instructions, wherein the computer-executable instructions, when executed by a computer processor, causing the computer processor to:
acquire an image sequence of a target object in response to a live body detection trigger operation, wherein the image sequence comprises an image to be detected;
determine, for the image to be detected, multiple frames of reference images associated with the image to be detected in acquisition time from the image sequence;
determine a risk factor of the image to be detected based on a region to be detected in the multiple frames of reference images, wherein the region to be detected at least comprises a region where a verification organ performing a preset verification action is located, and the risk factor indicates whether the target object is a live body; and
determine a live body detection result corresponding to the target object based on the risk factor of the image to be detected.

15. (canceled)

16. The device of claim 13, wherein the program causing the at least one processor to determine a risk factor of the image to be detected based on a region to be detected in the multiple frames of reference images comprises instructions to:
determine, for each frame of reference image, a binarized image of a region to be detected in the reference image;
count a quantity of pixel points with a same pixel value in the binarized image to obtain a pixel point statistics value; and
determine the risk factor of the image to be detected based on pixel point statistics values of at least two frames of reference images in the multiple frames of reference images.

17. The device of claim 16, wherein the program causing the at least one processor to determine a binarized image of a region to be detected in the reference image comprises instructions to:
crop the region to be detected in the reference image to obtain an image of the region to be detected; and
perform binarization on the image of the region to be detected to obtain the binarized image.

18. The method for image processing of claim 16, wherein the program causing the at least one processor to determine a binarized image of a region to be detected in the reference image comprises instructions to:
perform binarization on the reference image; and
crop the region to be detected in the binarized reference image to obtain the binarized image.

19. The device of claim 16, wherein the program causing the at least one processor to determine a risk factor of the image to be detected based on pixel point statistics values of at least two frames of reference images in the multiple frames of reference images comprises instructions to:
calculate a variance of pixel point statistics values of the at least two frames of reference images in the multiple frames of reference images; and
determine the risk factor of the image to be detected based on the variance.

20. The device of claim 19, wherein the program causing the at least one processor to calculate a variance of pixel point statistics values of the at least two frames of reference images in the multiple frames of reference images comprises instructions to:
obtain at least two frames of reference images within a preset acquisition time range in the multiple frames of reference images; and
calculate the variance of pixel point statistics values of the at least two frames of reference images.

21. The device of claim 20, wherein the program causing the at least one processor to calculate a variance of pixel point statistics values of the at least two frames of reference images in the multiple frames of reference images comprises instructions to:
obtain a preset quantity of reference images in the multiple frames of reference images to calculate the variance of pixel point statistics values of the preset quantity of reference images.

22. The device of claim 16, wherein the program causing the at least one processor to determine a live body detection result corresponding to the target object based on the risk factor of the image to be detected comprises instructions to:
determine the live body detection result corresponding to the target object based on the risk factor of the image to be detected and a preset risk factor threshold.
